(19) United States
(12) Patent Application Publication
(10) Pub. No.: US 2006/0199734 A1
(43) Pub. Date: Sep. 7, 2006

(54) Image data delivery system

(75) Inventors: Yoshihiro Yamashita, Hirakata-shi (JP); Masaki Asano, Nishinomiya-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/361,743

(22) Filed: Feb. 24, 2006

(30) Foreign Application Priority Data
Mar. 1, 2005 (JP) 2005-56594

(51) Int. Cl. B41M 5/24

(52) U.S. Cl. 503/227

(57) ABSTRACT

A plurality of data storing servers 3 are connected on a communication network 6. A plurality of cameras 2 connected with the communication network 6 are divided into a plurality of groups, and the respective groups are related to the respective data storing servers 3 in correspondence. The respective data storing servers 3 import images from the cameras 2 belonging to the corresponding groups and store the imported images. If a request for the supply of an image to the camera 2 or the data storing server 3 is entered by means of an entry unit 28 in a PC 4, information representing this request is transmitted from the PC 4 to the camera 2 or the data storing server 3 via the communication network 6. Upon the request of the image from the PC 4, the camera 2 transmits an image obtained by a photographing operation in a target area to the PC 4 via the communication network 6. Upon the request of the image from the PC 4, the data storing server 3 supplies a requested image stored therein to the PC 4. An image data delivery system capable of simply improving a server function can be provided.

This application is based on patent application No. 2005-56594 filed in Japan, the contents of which are hereby incorporated by references.

### BACKGROUND OF THE INVENTION

1. Field of the Invention

This invention relates to an image data delivery system for delivering image data obtained by an image pickup apparatus to a specified apparatus via a communication network.

2. Description of the Background Art

There have been proposed various image data delivery systems for delivering image data obtained by an image pickup apparatus to a specified apparatus via a communication network. FIG. 16 shows an exemplary conventional image data delivery system. As shown in FIG. 16, a conventional image data delivery system 100 is provided with a plurality of monitoring cameras 101, one server 102 for importing and storing image data obtained by photographing operations of the monitoring cameras 101, and a personal computer (hereinafter, “PC”) for browsing images obtained by photographing operations of the monitoring cameras 101, and image data generated by the monitoring camera 101 designated in the PC 103 is delivered from the server 102 via a communication network.

Japanese Unexamined Patent Publication No. 2002-101407 proposes an image data delivery system constructed such that monitoring cameras, one or more image storing servers and a user terminal unit for browsing or searching images obtained by monitoring cameras are connected via Internet, the image storing server receives image data generated by the monitoring cameras via a mobile phone and a mobile communication network, or a model and an ISDN circuit or a router, a LAN and Internet, stores the received image data, and supplies the image data to the user terminal unit or the mobile phone.

In the image data delivery system of this type, if the monitoring cameras increase in number or the personal computers receiving the images from the server increase in number, it is necessary to improve the delivery performance including the storage capacity of the server.

In the above image data delivery system for obtaining and storing image data from a plurality of monitoring cameras and delivering image data to a plurality of PCs by means of one server, the operation of the image data delivery system needs to be stopped in order to additionally install server(s), resulting in a fairly large-scale operation. Thus, there is a problem that users cannot receive an image data delivery service during a period of the additional installation. In the case of trying to remarkably improve the delivery performance of the servers by one additional installation in order to avoid frequent additional installation, a huge cost is required, and the performance of the servers may be possibly wasted if the servers have a delivery performance than necessary. Furthermore, since the servers provided in such an image data delivery system is large in the size, an installation place for the servers is limited.

The above publication discloses that a plurality of image storing servers are installed in the image data delivery system, but discloses neither a correspondence between the image storing servers and the monitoring cameras nor how the image data generated by a plurality of monitoring cameras are stored in the respective image storing servers.

### SUMMARY OF THE INVENTION

It is an object of the present invention to provide an image data delivery system which is free from the problems residing in the prior art.

It is another object of the present invention to provide an image data delivery system which can easily improve a server function.

According to an aspect of the present invention, an image data delivery system comprises a group including an image pickup apparatus for picking up a light image of an object to generate image data, and a server for importing image data from the image pickup apparatus via a communication network and storing the imported image data. The system is provided with an image displaying apparatus for importing image data from the image pickup apparatus or the server via the communication network and displaying an image of the imported image data. The image displaying apparatus has a first display mode for displaying an image upon receiving image data from the image pickup apparatus and a second display mode for displaying an image upon receiving image data from the server.

These and other objects, features, aspects and advantages of the present invention will become more apparent upon a reading of the following detailed description and accompanying drawings.

### BRIEF DESCRIPTION OF THE DRAWINGS

FIG. 1 is a diagram showing a construction of an image data delivery system;

FIG. 2 is a diagram showing an electrical construction of a camera;

FIG. 3 is a diagram showing an electrical construction of a data storing server;

FIG. 4 is a diagram showing an electrical construction of a PC;

FIG. 5 is a diagram showing an exemplary screen to be displayed on a display unit of the PC when a delivery data display program is started;

FIG. 6 is an enlarged view of camera operating buttons;

FIG. 7 is a diagram showing an exemplary single liveview display screen;

FIG. 8 is a diagram showing an exemplary playback display screen;

FIG. 9 is a diagram showing an exemplary concurrent liveview display screen;

FIG. 10 is a diagram showing a search screen used to search images using an event data;

FIG. 11 is a diagram showing an exemplary search result display screen;

FIG. 12 is a flowchart showing a communication processing conducted upon transferring data between the PC and the camera;

FIG. 13 is a flowchart showing a communication processing conducted upon transferring the data between the PC and the data storing server;

FIG. 14 is a flowchart showing a communication processing conducted between the PC and the camera in the case of installing a new camera on a communication network;

FIG. 15 is a flowchart showing a communication processing conducted between the PC and the data storing server in the case of connecting a new data storing server on the communication network; and

FIG. 16 is a diagram showing a construction of a conventional image data delivery system.

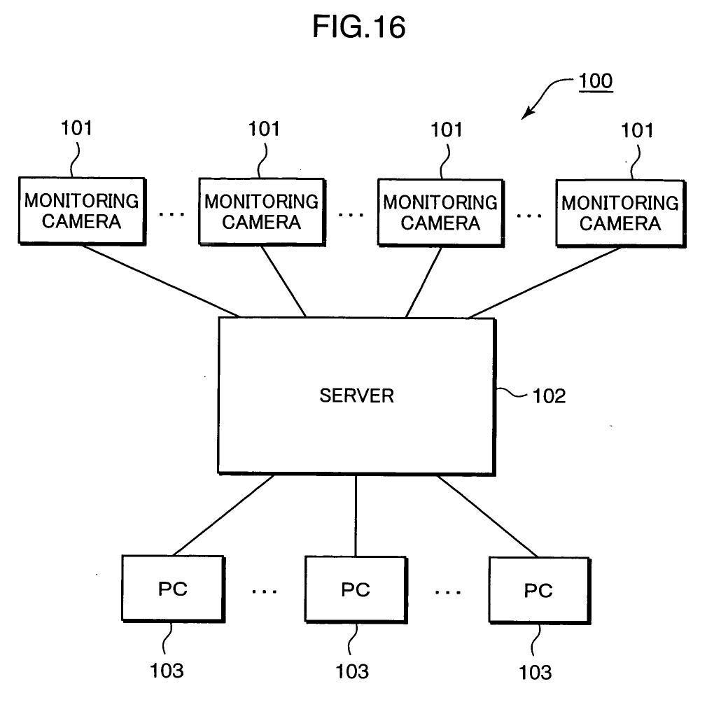

### DETAILED DESCRIPTION OF THE PREFERRED EMBODIMENTS OF THE INVENTION

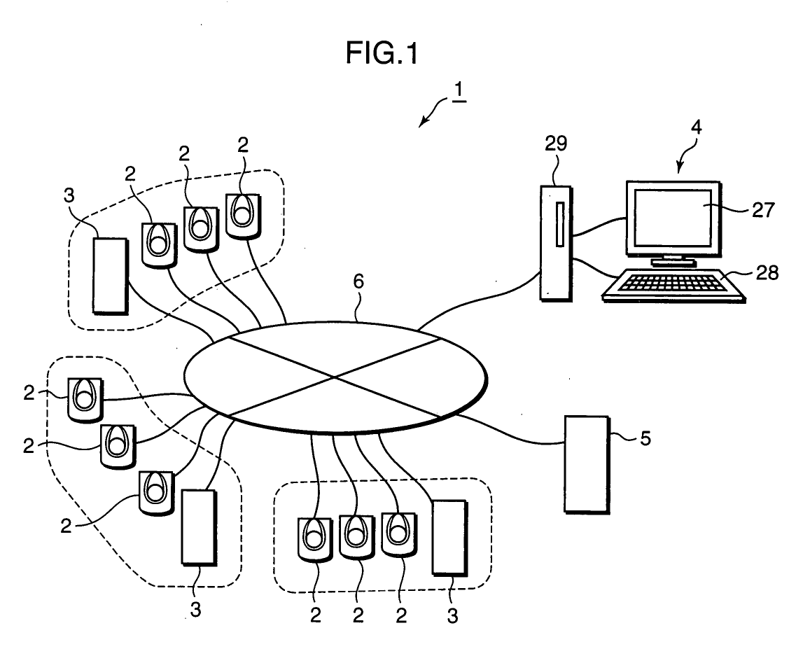

An image data delivery system according to an embodiment of the present invention is described. Referring to FIG. 1 showing a construction of the image data delivery system 1, the image data delivery system 1 is provided with cameras or image pickup apparatuses 2, data storing servers 3, a personal computer (hereinafter, “PC”) or image displaying apparatus 4 and an accounting server 5, and constructed such that these elements 2, 3, 4 and 5 can communicate with one another via a communication network 6 including a public telephone line and an exclusive line by a communication method utilizing, for example, TCP/IP (transmission control protocol/internet protocol).

For the cameras 2 and the data storing servers 3 connected with the communication network 6 at the time of building the image data delivery system 1, pieces of unique information used to identify them on the communication network 6 are stored in the PC 4. For the cameras 2 and the data storing servers 3 to be additionally connected with the communication network 6, pieces of unique information of the added devices are registered in the PC 4 by an entry operation by a user.

In this image data delivery system 1, a plurality of data storing servers 3 are connected with the communication network 6. On the other hand, a plurality of cameras 2 connected with the communication network 6 are divided into a plurality of groups, which are related to the respective data storing servers 3 in correspondence. The respective data storing servers 3 import data including images from the cameras 2 belonging to the corresponding groups and store the imported data.

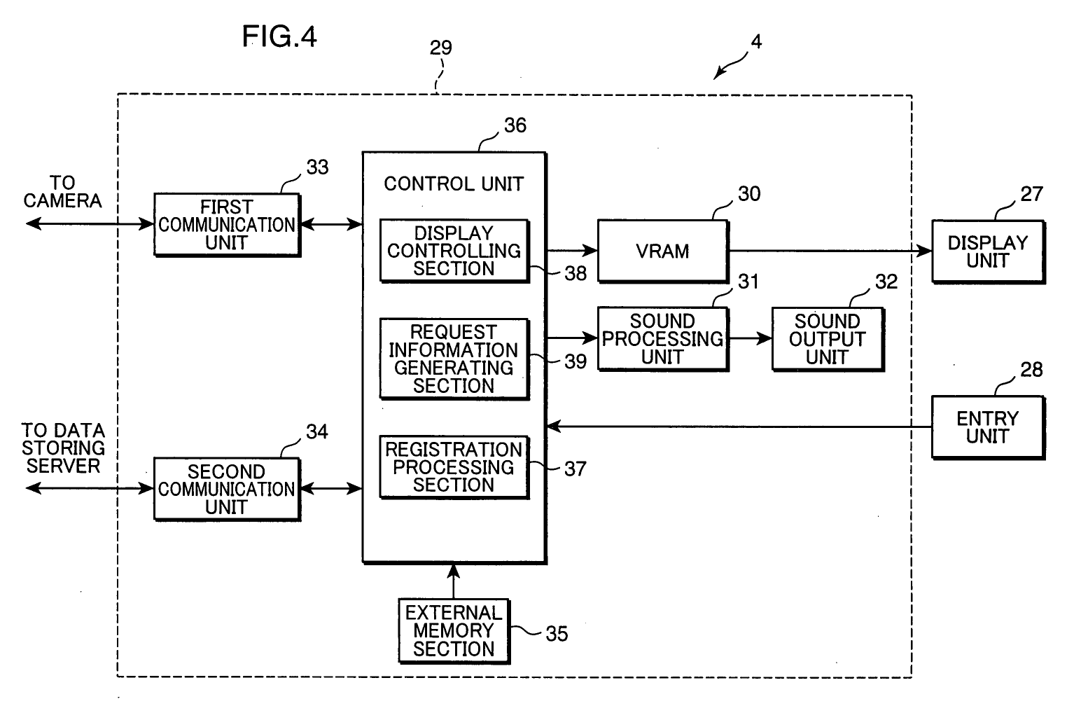

The PC 4 requests data to the camera 2 based on the user's instruction, receives data obtained by a photographing operation of this camera 2 and displays them on a display unit 27 (see FIG. 4) to be described later. The PC 4 also requests data to the data storing server 3 based on the user's instruction, receives data from the data storing server 3 and displays them on the display unit 27.

Specifically, when the user enters the request of images or other data to the camera 2 or the data storing server 3 using an entry unit 28 in the PC 4, information representing this request is transmitted from the PC 4 to the camera 2 or the data storing server 3 via the communication network 6. Upon the data request from the PC 4, the camera 2 transmits data, e.g., image data generated by photographing operations in a target area, to the PC 4 via the communication network 6. On the other hand, the data storing server 3 supplies requested data stored therein to the PC 4.

The camera 2 transmits data, e.g., image data, to the corresponding data storing server 3 on a steady basis, and the data storing server 3 stores the received data. Data transferred between the cameras 2, the data storing servers 3 and the PC 4 are mainly data of images photographed by the cameras 2, but also contain other data.

Thus, images of an object in the target area can be displayed in real time on the display unit 27 of the PC 4 by the supply of image data from the camera 2 to the PC 4, and already-stored image data (still image data or moving image data obtained and stored in the past) can be displayed on the display unit 27 (see FIG. 4) of the PC 4 by the supply of image data from the data storing server 3 to the PC 4.

In FIG. 1, the accounting server 5 charges the user of the image data delivery system 1, for example, depending on a data communication time between the camera 2 or the data storing server 3 and the PC 4.

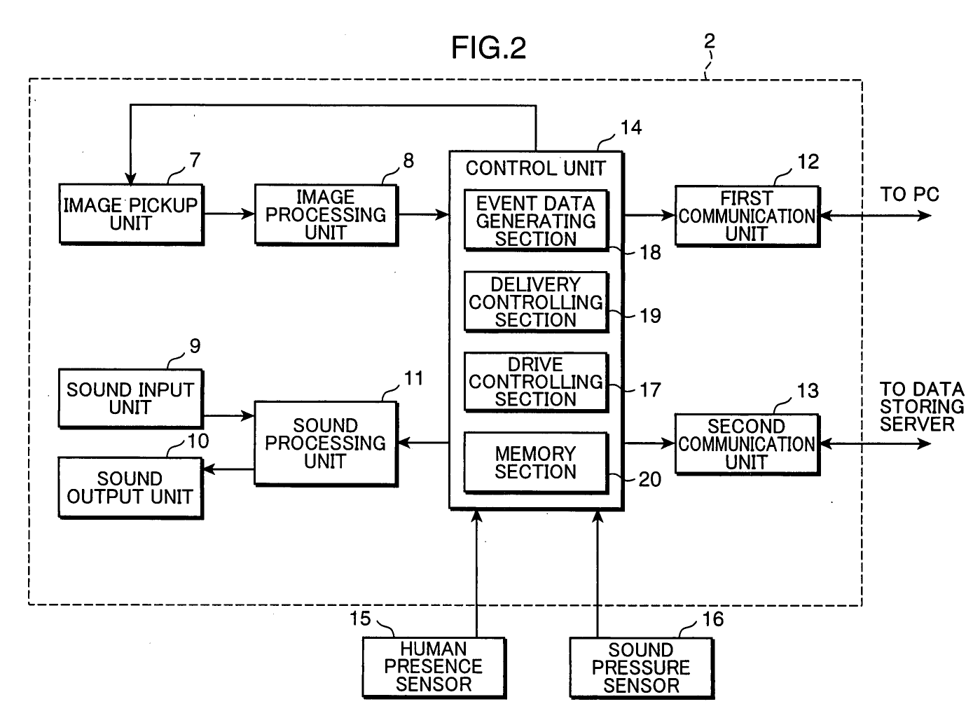

FIG. 2 is a diagram showing an electrical construction of the camera 2.

As shown in FIG. 2, the camera 2 is used as a monitoring camera for monitoring a specified area, and includes an image pickup unit 7, an image processing unit 8, a sound input unit 9, a sound output unit 10, a sound processing unit 11, a first communication unit 12, a second communication unit 13 and a control unit 14.

Although not shown, the image pickup unit 7 is comprised of a photographing optical system for picking up a light image of an object, and an image pickup device for receiving the light image of the object picked up by the photographing optical system and conducting a photoelectric conversion based on the received light image. The photographing optical system includes a zoom lens for changing a photographing magnification (focal length), and a focusing lens for adjusting a focal position. The image pickup unit 7 is constructed such that the optical axis of the photographing optical system is movable along vertical direction (hereinafter, “tilting direction”) and transverse direction (hereinafter, “panning direction”) by means of an unillustrated geared motor.

The image pickup device includes a CMOS (complementary metal-oxide semiconductor) color area sensor having a Bayer array in which a number of photoelectric conversion elements such as photodiodes are two-dimensionally arrayed in a matrix and color filters, e.g., R (red), G (green) and B (blue) filters, having different spectral characteristics are arranged at a ratio of 1:2:1 on the light receiving surfaces of the respective photoelectric conversion elements. The image pickup device converts the light image of the object focused by the photographing optical system into analog electrical signals (image signals) of the respective colors R, G, B, and outputs as the image signals of the respective colors R, G, B. It should be noted that the image pickup device may-include a CCD (charge coupled device) or the like.

The image processing unit 8 applies amplification, an A/D (analog-to-digital) conversion, a white balance adjustment, a γ correction and other image processings to the image data outputted from the image pickup device.

The sound input unit 9 is adapted for inputting the voice of a user of the monitoring camera 1 and other sounds, and includes a microphone for converting a sound into an electrical signal. The sound output unit 10 is adapted for outputting voices and other sounds transmitted from other communication equipments to the outside, and includes a loudspeaker for converting an electrical signal into a sound. The sound processing unit 11 applies specified processings to electrical signals from the sound input unit 9, and outputs processed electrical signals to the sound output unit 10 in accordance with the control unit 14.

The first and second communication units 12, 13 transmit and receive data, e.g., image data, sound data, to and from the PC 4 and the data storing server 3 via the communication network 6, for example, in accordance with the 100 Base-T standard.

As shown in FIG. 2, the camera 2 is provided with terminals for the connection with external apparatuses so as to be capable of receiving signals generated in the external apparatuses connected with the terminals or outputting specified signals to the external apparatuses to cause the external apparatuses to perform specified operations. The external apparatuses connectable with the camera 2 include a human presence sensor, a sound pressure sensor, a temperature sensor, a humidity sensor, a gas detecting sensor, an opening/closing sensor for a lid/window, a vibration sensor, and a Patlite (registered trademark). In this embodiment, it is assumed that a human presence sensor 15 and a sound pressure sensor 16 are connected with the camera 2 as shown in FIG. 2.

The human presence sensor 15 is for detecting the presence or absence of a person in a specified area using, for example, a LED light, an infrared ray, or an ultrasonic wave as a detection medium. If the entrance of a person into the specified area is detected by the human presence sensor 15, the optical axis of the camera 2 (photographing optical system) is moved in panning direction or tilting direction toward the specified area to pick up an image of the specified area.

The sound pressure sensor 16 includes, for example, a microphone of the piezoelectric type or electrostatic capacity type and is adapted to detect the presence or absence of a sound pressure (aerial vibration) exceeding a predetermined threshold value. Hereinafter, an occurrence of a situation where the entrance of a person into the specified area is detected by the human presence sensor 15 and an occurrence of a situation where the sound pressure detected by the sound pressure sensor 16 exceeds the predetermined threshold value are referred to occurrences of events.

Upon the output of a detection signal representing an occurrence of an event from the human presence sensor 15 or the sound pressure sensor 16, an event data is generated based on the detection signal by the control unit 14 to be described later and transmitted to the data storing server 3 and the PC 4 together with an image. The data storing server 3 stores this event data and the image in correspondence and the PC 4 displays the event data on the display unit 27 (see FIG. 4) together with the image upon receiving the event data.

On the display unit 27 of the PC 4, the event data is displayed with links as described later, and images picked up around a point of time when the event relating to this event data occurred are obtained from the data storing server 3 and displays by performing a specified operation to a display area of the event data.

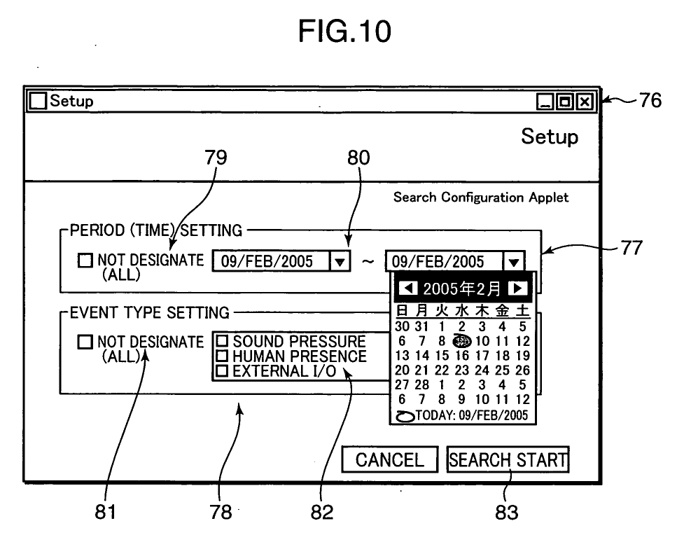

In this embodiment, image data can be searched by means of a search screen 76 (see FIG. 10) to be described later using an event data as a search key. For example, if targeted images are images of objects emitting sounds whose sound pressures exceeded a predetermined threshold value, the targeted images can be narrowed down to those related to event data representing occurrences of a situation where the sound pressure exceeds the predetermined threshold value from a plurality of images stored in the data storing server 3 by entering a search key corresponding to this event on the search screen 76. Thus, desired image data can be quickly and easily searched.

The control unit 14 is constructed, for example, by a microcomputer having a built-in memory section 20 including a ROM storing a control program and a RAM for temporarily saving data, and controls the operations of the respective elements of the aforementioned camera 2 while relating them to each other.

The control unit 14 is functionally provided with a drive controlling section 17, an event data generating section 18 and a delivery controlling section 19. The drive controlling section 17 is adapted for controllably driving various motors to drive the photographing optical system along the optical axis and to move the optical axis of the photographing optical system in panning or tilting direction upon receiving a request from the PC 4. Thus, the camera 2 can be remotely operated from the PC 4.

The event data generating section 18 is adapted for generating the aforementioned event data including time data based on the detection signal from the human presence sensor 15 or the sound pressure sensor 16.

The communication controlling section 19 causes the first and second communication units 12, 13 to transmit the image obtained by the photographing operation of the image pickup unit 7, the sound data obtained by the sound inputting operation of the sound input unit 9 and the event data generated by the event data generating section 18 to the PC 4 as a requesting end and the data storing server 3 corresponding to this camera 2 while relating the respective data to each other. Hereinafter, the image data, the sound data and the event data related to each other are collectively referred to as delivery data.

The memory section 20 is for storing various data including the unique information of the data storing server 3 and the PC 4 set as data delivering ends of the camera 2.

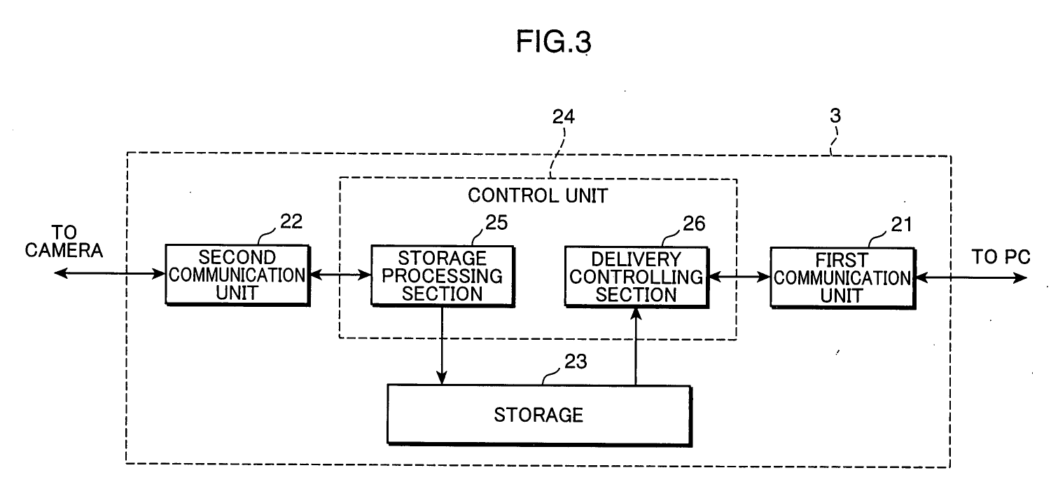

FIG. 3 is a diagram showing an electrical construction of the data storing server 3. As shown in FIG. 3, the data storing server 3 is provided with a first communication unit 21 and a second communication unit 22, a storage 23 and a control unit 24.

The first and second communication units 21, 22 transmit and receive the delivery data to and from the PC 4 and the cameras 2, for example, in accordance with the 100 Base-T standard.

The storage 23 is, for example, a hard disk or an optical disk for storing the delivery data. Data stored in the storage 23 include pieces of unique information of the cameras 2 belonging to the corresponding group and the PC 4 as a data delivering end of the data storage server 3.

The control unit 24 is constructed, for example, by a microcomputer having an unillustrated built-in memory section including a ROM storing a control program and a RAM for temporarily saving data, and controls the operations of the first and second communication units 21, 22 and the storage 23 described above while relating them to each other. Further, the control unit 24 is functionally provided with a storage processing section 25 and a delivery controlling section 26.

The storage processing section 25 is adapted for performing a processing to store the delivery data transmitted from the camera 2 in the storage 23.

The delivery controlling section 26 is adapted for, upon receiving a request from the PC 4, searching and reading the delivery data conforming to the content of the request and causing the first communication unit 21 to perform a processing to transmit the read delivery data to the PC 4.

FIG. 4 is a diagram showing an electrical construction of the PC 4. As shown in FIG. 4, the PC 4 is, roughly speaking, provided with the display unit 27, the entry unit 28 and a main assembly 29.

The display unit 27 includes a CRT (cathode-ray tube), an LCD (liquid crystal display) or a PDP (plasma display panel), and is adapted to display various data such as images and event data transmitted from the cameras 2 or the data storing servers 3. The entry unit 28 is adapted for entering various data and instructions to cause a control unit 36 and the like to perform specified processings and operations, and corresponds, for example, to a keyboard or a mouse.

The main assembly 29 is internally provided with a VRAM (video random access memory) 30, a sound processing unit 31, a sound output unit 32, a first communication unit 33 and a second communication unit 34, an external memory section 35 and the control unit 36. The VRAM 30 is a buffer memory for pixel signals of the image to be displayed on the display unit 27, and has a memory capacity for pixel signals corresponding to the number of pixels of the display unit 27.

The sound processing unit 31 is for applying specified processings to the sound data received from the cameras 2 and the data storing servers 3. The sound output unit 32 is for outputting the sound data from the cameras 2 and the data storing servers 3 as sounds to the outside and is constructed, for example, by a loudspeaker for converting an electrical signal into a sound.

The first and second communication units 31, 32 transmit and receive various data, e.g., image data, sound data and event data, to and from the cameras 2 and the data storing servers 3, for example, in accordance with the 100 Base-T standard.

The external memory section 35 includes a hard disk for storing various programs and data. Data stored in the external memory section 35 include pieces of unique information of the cameras 2 and the data storage server 3.

The control unit 36 is constructed by a microcomputer having a built-in internal memory section storing control programs, and controls the operations of the aforementioned elements while relating them to each other. The control programs stored in the control unit 36 include an application program for requesting the data delivery to the cameras 2 and the data storing servers 3 and for displaying data such as images photographed by the cameras and images supplied from the data storing servers 3 on the display unit 27, and the control unit 36 functions as a registration processing section 37, a display controlling section 38 and a request information generating section 39 by this application program. Hereinafter, this application program is referred to as a delivery data display program.

The registration processing section 37 is adapted for, upon the entry of the unique information of the camera 2 or the data storing server 3 on a specified entry screen by means of the entry unit 28, performing a processing to register (store) this unique information in the external memory section 35.

The display controlling section 38 is adapted for displaying various screens on the display unit 27. The various screens include a registration screen used to register the identification information of the camera 2 or the data storing server 3 in the PC 4 in the case of connecting a new camera 2 or a new data storing server 3 with the communication network 6, a request screen used to enter various requests including a request to deliver data such as images to the cameras 2 and the data storing servers 3, and an image display screen used to display data such as images delivered from the cameras 2 and the data storing servers 3.

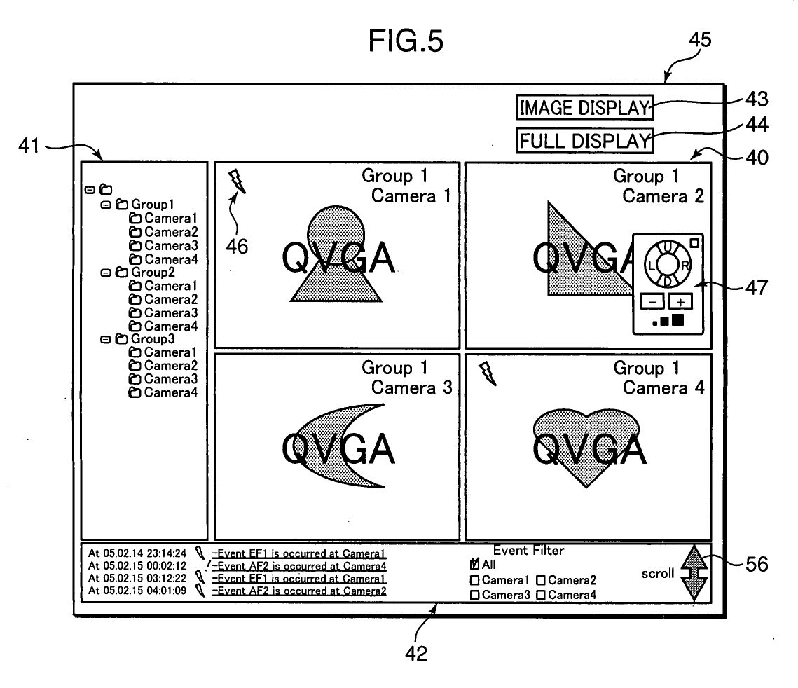

FIG. 5 is a diagram showing an exemplary screen displayed on the display unit 27 when the delivery data display program is started.

When the delivery data display program is started in the PC 4, a screen 45 (hereinafter, “multiple liveview display screen”) is displayed on the display unit 27. This screen 45 includes an image display area 40 for displaying images supplied from the camera 2, an administration information display area 41 arranged at a lateral side of the image display area 40, an event data display area 42 arranged below the image display area 40 and the administration information display screen 41, an image display button 43 and a full display button 44 arranged one above the other above the image display area 40.

In this embodiment, the number of the cameras 2 belonging to each group is equal to the number of images simultaneously displayed in the image display area 40, and the images are displayed in groups in the image display area 40. The images supplied from the cameras 2 belonging to each group are displayed, for example, in a 2×2 matrix array as shown in FIG. 5.

The images displayed in the image display area 40 immediately after the start of the display of the multiple liveview display screen 45 are those supplied from the cameras 2 belonging to the predetermined group out of the cameras 2 registered in the PC 4. The sounds outputted immediately after the start of the display of the multiple liveview display screen 45 are those corresponding to the image displayed in a specified area out of a plurality of images displayed in the image display area 40. When an image is designated through a specified operation by means of the entry unit 28, the sounds corresponding to the designated image are outputted.

The administration information display area 41 is an area where a list of the cameras 2 registered in the PC 4 (administration information) is displayed, and the names of the groups and the names of the cameras belonging to the respective groups are displayed in tree view. By performing a specified operation to the display area of the group name, the images displayed in the image display area 40 are switched to those supplied from the cameras 2 belonging to the group to which the specified operation was made.

The name of the camera 2 and the name of the group of the camera 2 as the image supplying end are displayed at specified positions of the display area of each image displayed in the image display area 40. Further, the name of the camera 2 or the data storing server 3 and a character 46 for visually notifying an occurrence of an event if an event data is supplied from the camera 2 are displayed at specified positions of the display area of each image displayed in the image display area 40. FIG. 5 shows a mode for notifying an occurrence of a sound pressure exceeding the predetermined threshold value by displaying the character simulating a lightening.

By performing a specified operation to the image displayed in the image display area 40 by means of the entry unit 28, virtual camera operating buttons 47 for entering various instructions and requests such as a request to pan or tilt the camera 2, a request to change the photographing magnification and an instruction as to whether or not sounds are to be outputted are displayed at a specified-position.

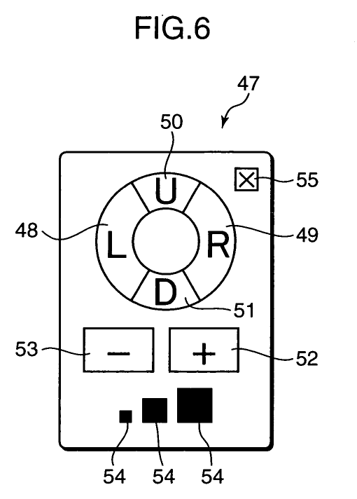

FIG. 6 is an enlarged view of the camera operating buttons 47. The camera operating buttons 47 are displayed upon performing the specified operation by means of the entry unit 28, and include buttons 48, 49 used to instruct a panning movement, a button 50 used to instruct a titling movement, a zoom button 52 used to set the photographing optical system of the camera 2 toward a telephoto side, a wide-angle button 53 used to set the photographing optical system of the camera 2 toward a wide-angle side, a volume setting button 54 used to set any one of a plurality of settable volumes for the sounds outputted from the sound output unit 32, and a close button 55 used to erase the camera operating buttons 47.

The event data display area 42 is an area for displaying the event data transmitted from the cameras 2 registered in the PC 4 while the images are delivered from the cameras 2. Every time an event occurs in any one of the cameras 2, event-related data are vertically displayed in the form of a list with one set of event-related data comprised of an event occurrence time, the content of the event, and the unique information of the camera 2.

It is set to scroll-display the event-related data if they cannot be displayed at once within the event data display area 42. The event-related data are scrolled by operating a scroll button 56 arranged at a specified position within the area 42.

In this embodiment, the cameras 2 for supplying the event-related data to the PC 4 can be designated. More specifically, an item “All” for setting all the cameras 2 registered in the PC 4 as the cameras 2 for supplying the event-related data, and the names of the respective cameras 2 belonging to the group supplying the images being currently displayed in the image display area 40 to designate the desired camera 2 from those belonging to this group are displayed at specified positions in the event data display area 42. By designating any one of the cameras 2, the camera 2 for supplying the event-related data to the PC 4 can be designated.

The image display button 43 and the full display button 44 are buttons for switching a mode between a full display mode in which all the images displayed in the image display area 40, the list of all the cameras 2 displayed in the administration information display area 41 and all the event-related data displayed in the event data display area 42 are displayed as shown in FIG. 5 and an image display mode in which only the images displayed in the image display area 40 in the full display mode are displayed on the entire screen of the display unit 27. The image display mode is set when the image display button 43 is operated, whereas the full display mode is set when the full display button 44 is operated.

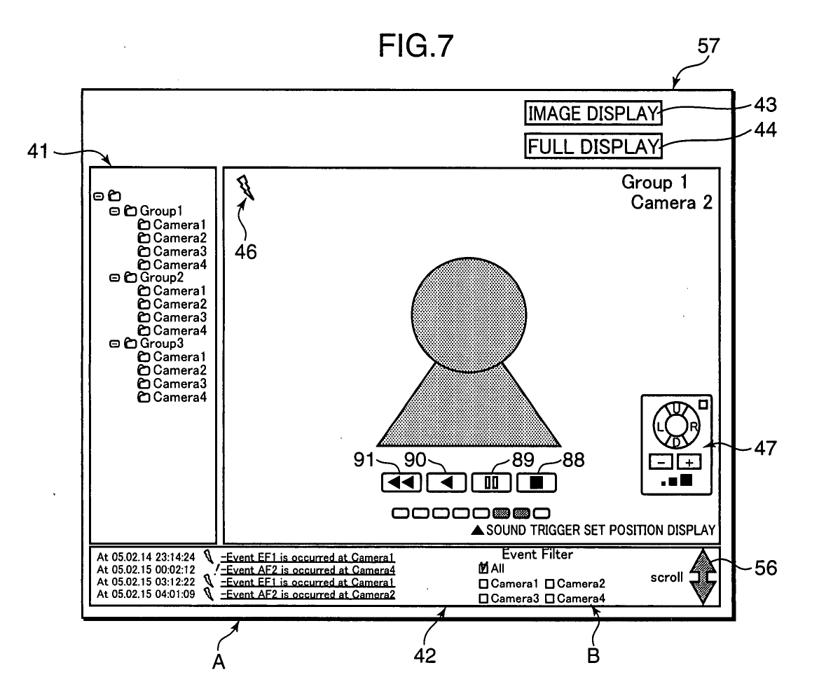

If a specified operation is performed to any of the images displayed in the image display area 40 on the multiple liveview display screen 45 as above, the screen is switched to a single liveview display screen 57 as shown in FIG. 7.

As shown in FIG. 7, the single liveview display screen 57 is substantially the same as the multiple liveview display screen 45 except that an enlarged image of the image to which the specified operation was performed is displayed in an area corresponding to the image display area 40 on the multiple liveview display screen 45. On this screen as well, camera operating buttons 47 similar to the aforementioned ones are displayed at a specified position by performing a specified operation to the displayed image by means of the entry unit 28.

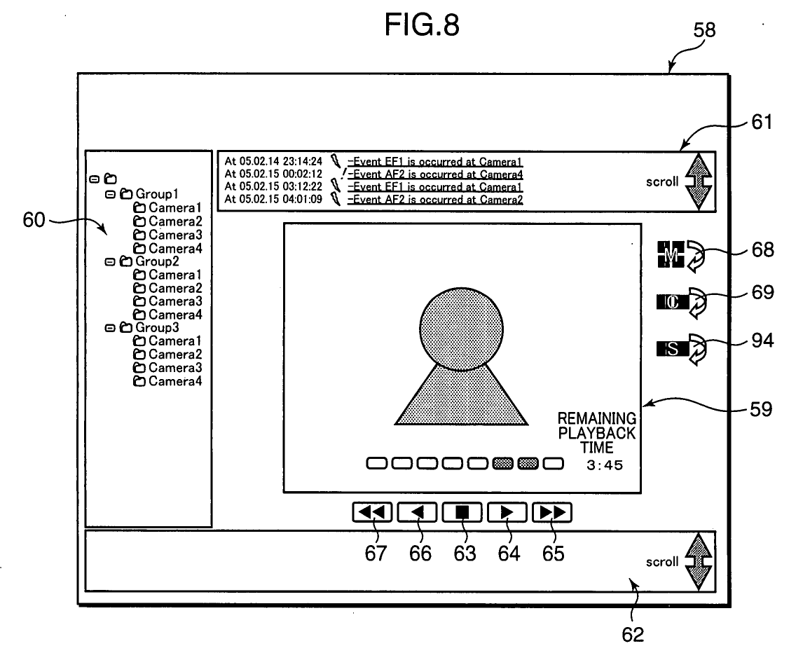

On the other hand, as described above, the links are provided in the display area of the event-related data displayed in the event data display area 42, and the screen is switched to a playback view display screen 58 as shown in FIG. 8 when a specified operation is performed to the display area of any of the event-related data.

A stop button 88 for instructing the stop of the playback, a pause button 89 for instructing the pause of the playback, a first rewind button 90 for instructing the successive display of images photographed at timings going back at specified intervals from the photographed timing of the image being currently displayed, and a second rewind button 91 for instructing the return to the image photographed at and after a timing going back a specified period from the photographed timing of the image being currently displayed are provided below the image display area.

If the first or second rewind button 90 or 91 is operated, the PC 4 requests the data corresponding to the operated button to the data storing server 3 corresponding to the image being displayed. When the image data and the like are transmitted from the data storing server 3, the PC 4 switches the screen to the playback view display screen 58 as shown in FIG. 8 and displays the received images on this playback view display screen 58 and outputs sounds and the like.

As shown in FIG. 8, the playback view display screen 58 includes an image display area 59 arranged substantially in the center, an administration information display area 60 arranged at a lateral side of the image display area 59, and a first and a second event data display areas 61, 62 arranged above and below the image display area 59.

Images photographed at and after a point of time going back a specified time from the occurred timing of the event designated in the event data display area 42 of the multiple liveview display screen 40 (past moving image data stored in the data storing server 3) are played back in the image display area 59. A remaining playback time is displayed in numerical value and bars below the image displayed in the area 59.

Below the bars are provided a pause button 63, a first forward button 63, a second forward button 65, a first rewind button 66 and a second rewind button 67. The pause button 63 is for instructing the pause of the playback. The first forward button 64 is for instructing the successive display of images (still images), which were photographed at timings advanced at specified intervals from the photographed timing of the image being currently displayed, at specified time intervals. The second forward button 65 is for instructing the display of the image photographed at a timing advanced by a specified period from the photographed timing of the image being currently displayed. The first rewind button 66 is for instructing the successive display of images photographed at timings going back at specified intervals from the photographed timing of the image being currently displayed. The second rewind button 67 is for instructing the return to the image photographed at a timing going back a specified period from the photographed timing of the image being currently displayed and the display of the images photographed at and after this timing.

The pause button 63 functions to instruct the pause of the playback when the image is being played back in the image display area 59 while functioning to instruct the resume of the image playback when the playback of the image is in pause through the operation of the pause button 63.

The administration information display area 60 and the first event data display area 61 are not described here since they are for displaying information substantially similar to those displayed in the administration information display area 41 and the first event data display area 52 of the multiple liveview display screen 45. The second event data display area 62 is an area for displaying events occurred to the cameras 2 supplying images played back in the image display area 59 while these images are picked up.

A first mode changeover button 68, a second mode changeover button 69 and a third mode changeover button 94 are provided at a lateral side of the image display area 59. The first mode changeover button 68 is a virtual button for switching over to a mode in which the multiple liveview display screen 45 is displayed on the display unit 27. The second mode changeover button 67 is a virtual button for switching over to a mode in which a concurrent liveview display screen 70 to be described next is displayed on the display unit 27. The third mode changeover button 94 is a virtual button for switching over to a mode in which the single liveview display screen 57 is displayed on the display unit 27. When the third mode changeover button 94 is operated, the PC 4 receives the image data from the camera 2 having supplied the image being displayed in the playback view display screen 58 to the data storing server 3 and displays them on the single liveview display screen 57.

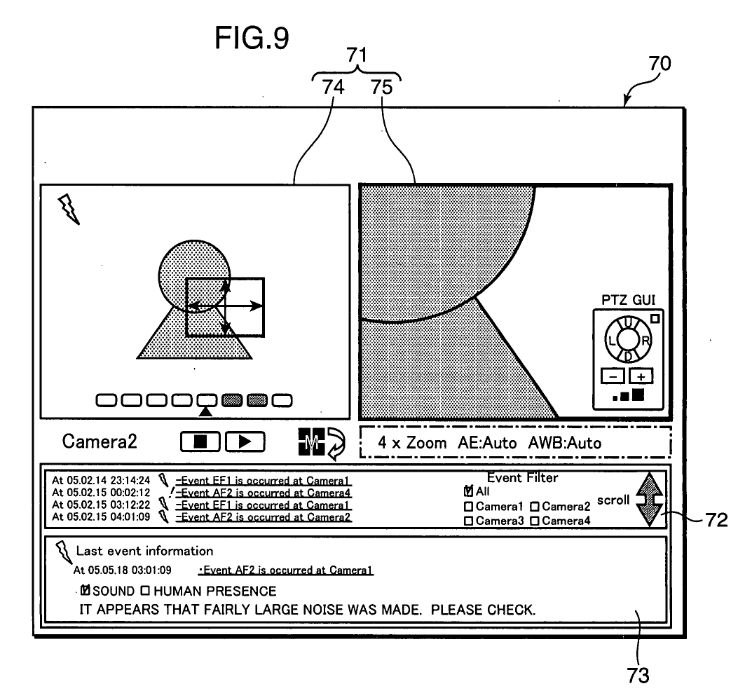

FIG. 9 is a diagram showing one example of the concurrent liveview display screen 70. As shown in FIG. 9, the concurrent liveview display screen 70 includes an image display area 71 for displaying images, a first event data display area 72 arranged below the image display area 71, and a second event data display area 73 arranged below the first event data display area 72.

The image display area 71 is an area defined by transversely juxtaposing a life-sized image display area 74 for displaying a life-sized image of a desired object and an enlarged image display area 75 for displaying an enlarged image of part of this object at a magnification larger than the life-sized image. The life-sized image is an image obtained by compressing (pixel skipping) an image obtained through the photographing operation of the image pickup device of the camera 2 at a specified compression rate. The enlarged image is an image obtained by extracting an area, designated by means of the entry unit 28, of the image obtained through the photographing operation of the image pickup device. By designating a desired area of the life-sized image through a specified operation by means of the entry unit 28, the image of the designated area is enlargedly displayed in the enlarged image display area 75.

The first event data display area 72 is an area for displaying contents substantially similar to those displayed in the event data display area 41 of the multiple liveview display screen 45, whereas the second event data display area 73 is an area for displaying a latest event data inputted to the camera 2 supplying the image being displayed in the image display area 71.

As described above, images can be searched using the event data in this embodiment. FIG. 10 shows the search screen 76 used to search images using the event data.

As shown in FIG. 10, the search screen 76 includes a period designating area 77 used to designate a photographing period of images to be searched, and a type designating area 78 used to designate the type of the event data. The period designating area 77 is comprised of a display area 79 used to enter whether or not the photographing period is to be designated, and display-areas 80 used to enter the date defining the photographing period. In each display area 80, a calendar is displayed through a specified operation by means of the entry unit 28, and the date can be entered using this calendar.

The type designating area 78 is comprised of a display area 81 used to enter whether or not the type of the event data is to be designated, and a display area 82 for displaying the type of the event data. The display of “EXTERNAL I/O” in FIG. 10 indicates a state where no external equipment such as the aforementioned gas detecting sensor is not connected with the terminal of the camera 2 in addition to the human presence sensor 15 and the sound pressure sensor 16. If the external equipment is connected with the terminal, the name of the connected external equipment is displayed in this display area.

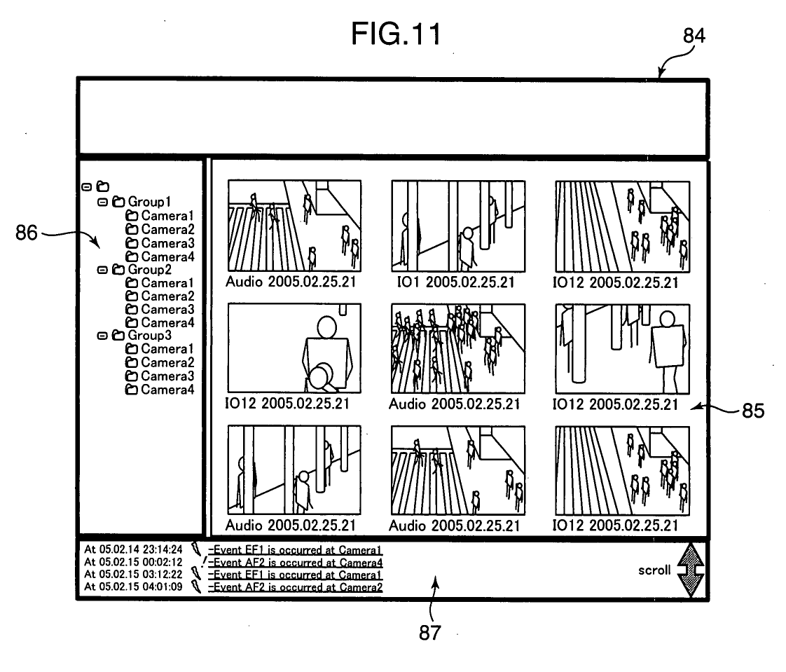

By operating a search start button 83 by means of the entry unit 28 after the photographing period of the images to be searched is designated and the type of the event data is designated on the search screen 76, the images conforming to the designated photographing period and the type of the event data are supplied from the data storing server 3 and a search result display screen 84, for example, as shown in FIG. 11 is displayed.

As shown in FIG. 11, the search result display screen 84 includes an image display area 85 for displaying the images supplied from the data storing server 3, an administration information display area 86 arranged at a lateral side of the image display area 85, and an event data display area 87 arranged below the image display area 85 and the administration information display area 86.

The image display area 85 is an area for displaying the images conforming to the photographing period and the type of the event data designated on the search screen 76. If there exist a plurality of such images, thumbnail images thereof are displayed, for example, in a 3×3 matrix array as shown in FIG. 11. The administration information display area 86 and the event data display area 87 have substantially the same displayed contents as the administration information display area 41 and the event data display area 42 shown in FIG. 5.

If a specified operation is performed to any one of the images (thumbnail images) on such a search result display screen 84 by means of the entry unit 84, the playback view display screen 58 is displayed as shown in FIG. 8 for the image to which the specified operation was performed.

Referring back to FIG. 4, the request information generating section 39 is for generating request information corresponding to a specified operation made to the aforementioned various screens by means of the entry unit 28. The request information includes information requesting the establishment or disconnection of the communication with the camera 2 or the data storing server 3, information requesting the delivery of data including images to the camera 2 or the data storing server 3, information requesting the panning/tilting movement of the camera 2 and the drive of the photographing optical system along the optical axis, information requesting the stop of the image supply from the camera 2 or the data storing server 3, and information requesting the switch to the image corresponding to the button operation when the first forward button 64 or the other button is operated.

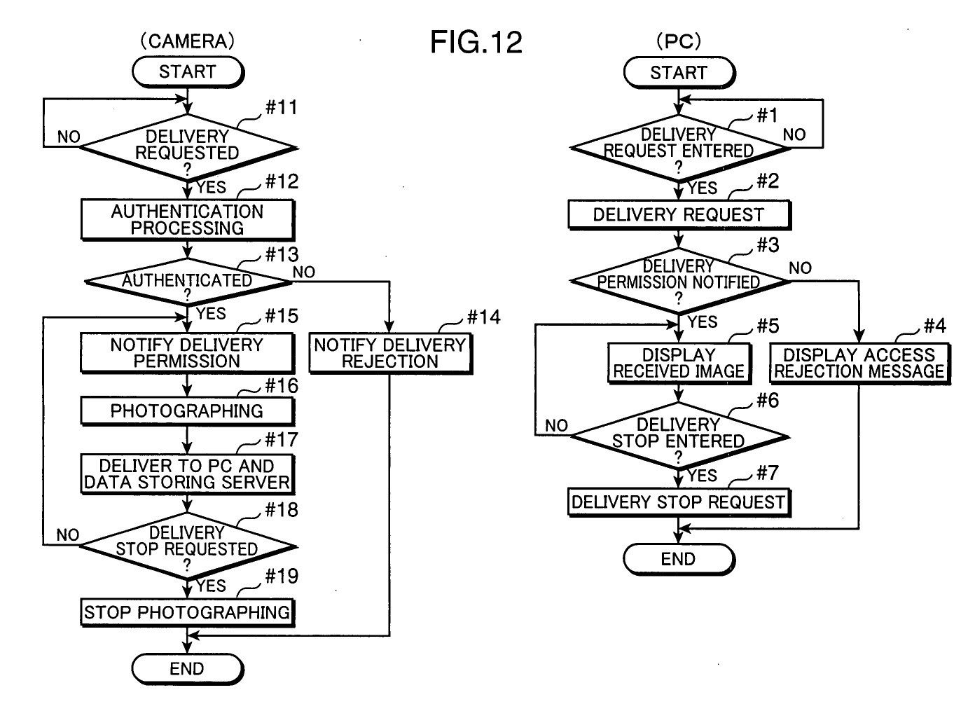

Next, the communication processings conducted between the PC 4, the cameras 2 and the data storing servers 3 are described. FIG. 12 is a flowchart showing the communication processing conducted upon transferring data between the PC 4 and the camera 2.

As shown in FIG. 12, if an entry is made to request the delivery of image data to the camera 2 by means of the entry unit 28 in the PC 4 (YES in Step #1), the control unit 36 generates a data representing the request of the data delivery (delivery request data) and transmits the generated data to the camera 2 (Step #2).

In the camera 2, upon receiving the delivery request data from the PC 4 (YES in Step #11), the control unit 14 executes an authentication processing as to whether or not the PC 4 having transmitted the delivery request data is the one registered in the camera 2 (Step #12). If the PC 4 having transmitted the delivery request data is not the one registered in the camera 2 as a result of the authentication processing (NO in Step #13), the control unit 14 generates data representing the rejection of the data delivery (delivery reject data) and transmits the generated data to the PC 4 (Step #14). On the other hand, if the PC 4 having transmitted the delivery request data is the one registered in the camera 2 (YES in Step #13), the control unit 14 generates data representing the permission of the data delivery (delivery permit data) and transmits the generated data to the PC 4 (Step #15).

Thereafter, the image pickup unit 7 is caused to perform the photographing operation and image data, sound data and event data in the case of an occurrence of any event are transmitted to the PC 4 until data representing the request of the stop of the data delivery (delivery stop request data) is transmitted from the PC 4 (Step #16, Step #17 and NO in Step #18).

On the other hand, if the PC 4 receives no delivery permit data from the camera 2, the control unit 36 displays a message to the effect that access to the camera 2 has been rejected on the display unit 27 (Step #4). On the other hand, if the PC 4 receives the delivery permit data from the camera 2 (YES in Step #3), the image data, the sound data and the event data are displayed on the display unit 27 upon being received from the camera 2 until an entry is made to request the stop of the data delivery by means of the entry unit 28 (Step #5, NO in Step #6).

If an entry is made to request the stop of the data delivery by means of the entry unit 28 (YES in Step #6), the control unit 36 generates the delivery stop request data and transmits the generated data to the camera 2 (Step #7).

If the camera 2 receives the delivery stop request data from the PC 4 (YES in Step #18), the photographing operation is stopped (Step #19).

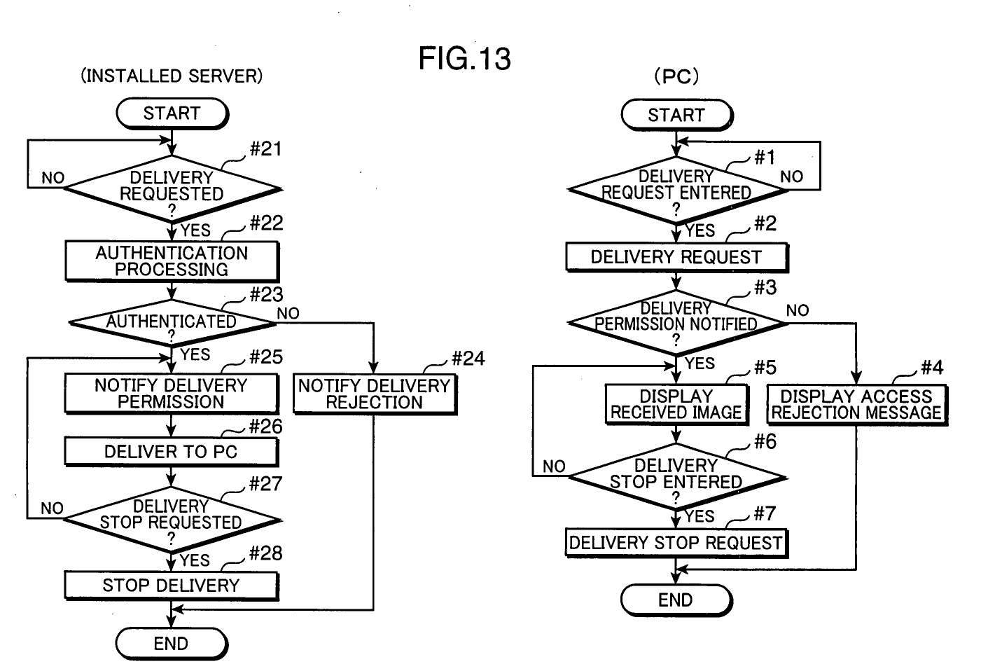

FIG. 13 is a flowchart showing a communication processing conducted upon transferring data between the PC 4 and the data storing server 3. Since the processings in the PC 4 are substantially similar to those shown in the flowchart of FIG. 12, the same step numbers as in FIG. 12 are appended thereto.

As shown in FIG. 13, if an entry is made to request a data delivery to the data storing server 3 through a specified operation of the entry unit 28 to any one of images displayed, for example, in the image display area on the multiple liveview display screen (YES in Step #1), the control unit 36 generates a data representing the request of the data delivery (data request data) and transmits the generated data to the data storing server 3 (Step #2).

If the data storing server 3 receives the delivery request data from the PC 4 (YES in Step #21), the control unit 24 executes an authentication processing as to whether or not the PC 4 having transmitted the delivery request data is the one registered in the data storing server 3 (Step #22). If the PC 4 having transmitted the delivery request data is not the one registered in the data storing server 3 as a result of the authentication processing (NO in Step #23), the control unit 14 generates data representing the rejection of the data delivery (delivery reject data) and transmits the generated data to the PC 4 (Step #24). On the other hand, if the PC 4 having transmitted the delivery request data is the one registered in the data storing server 3 (YES in Step #23), the control unit 14 generates data representing the permission of the data delivery (delivery permit data) and transmits the generated data to the PC 4 (Step #25).

Thereafter, image data, sound data stored in the storage 23, and event data if these data are related to the event data, are transmitted until data representing the request of the stop of the data delivery (delivery stop request data) is transmitted from the PC 4 (Step #26 and NO in Step #27).

If the PC 4 receives no delivery permit data from the data storing server 3 (NO in Step #3), a message to the effect that access to the data storing server 3 has been rejected is displayed on the display unit 27 (Step #4). On the other hand, if the PC 4 receives the delivery permit data from the data storing server 3 (YES in Step #3), the image data, the sound data and the event data, if any, are displayed on the display unit 27 upon being received from the data storing server 3 until an entry is made to request the stop of the data delivery by means of the entry unit 28 (Step #5, NO in Step #6).

If an entry is made to request the stop of the data delivery by means of the entry unit 28 (YES in Step #6), the control unit 36 generates delivery stop request data and transmits the generated data to the data storing server 3 (Step #7).

If the data storing server 3 receives the delivery stop request data from the PC 4 (YES in Step #27), the transmission or delivery of the data to the PC 4 is stopped (Step #28).

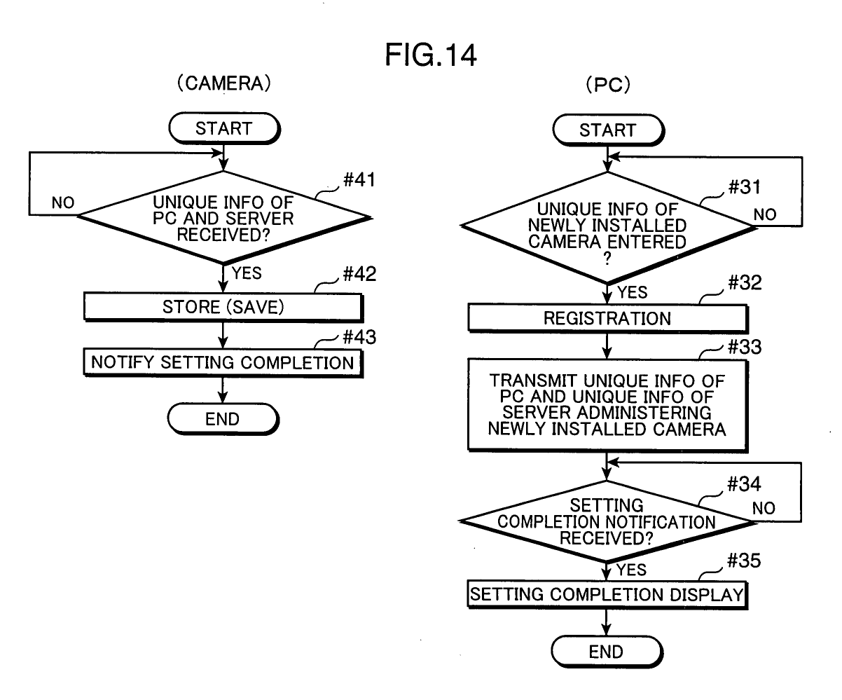

FIG. 14 is a flowchart showing a communication processing conducted between the PC 4 and the camera 2 in the case where a new camera 2 is installed on the communication network 6.

As shown in FIG. 14, if the unique information and the like of the newly installed camera 2 are entered by means of the entry unit 28 in the PC 4 (YES in Step #31), the control unit 36 stores (registers) the entered data such as registration information in the external memory section 35 (Step #32). Subsequently, the control unit 36 of the PC 4 transmits the unique information of the PC 4 and that of the data storing server 3 administering the newly installed camera 2 (data storing server 3 corresponding to the group the camera 2 belongs to) to the camera 2 (Step #33).

On the other hand, if the camera 2 receives the unique information of the PC 4 and that of the data storing server 3 (YES in Step S41), the control unit 14 stores these pieces of unique information in the memory section 20 (Step #42) and transmits to the PC 4 a setting completion notifying data to the effect that the PC 4 and this data storing server 3 are set as data transmitting ends from this camera 2 (Step #43).

If the PC 4 receives the setting completion notifying data from the camera 2 (YES in Step #34), the control unit 36 ends the processing after displaying a message to the effect that the setting of the newly installed camera 2 as a communication partner (data supplying end) of this PC 4 was completed on the display unit 27 (Step #35).

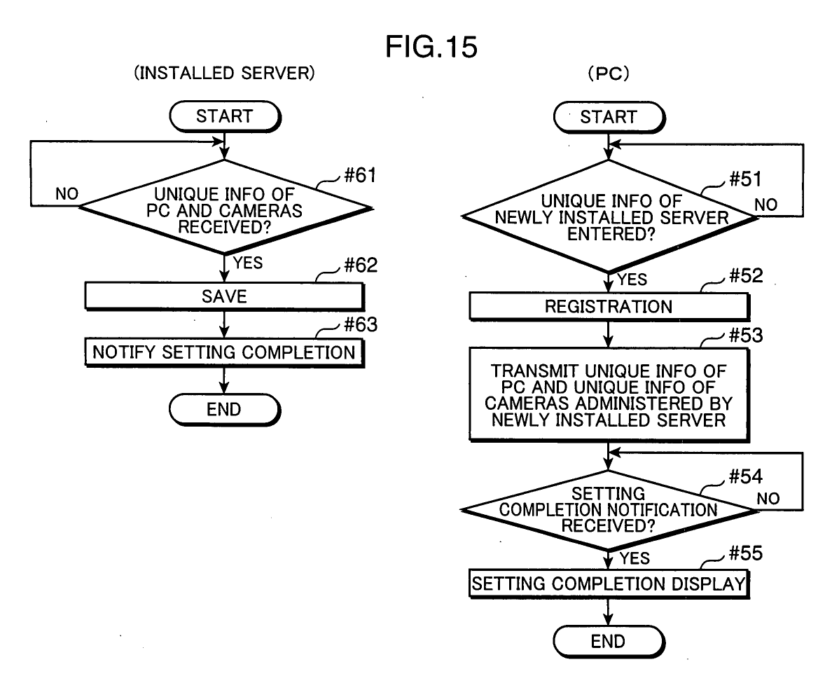

FIG. 15 is a flowchart showing a communication processing conducted between the PC 4 and the data storing server 3 in the case where a new data storing server 3 is installed on the communication network 6.

As shown in FIG. 15, if the unique information and the like of the newly installed data storing server 3 are entered by means of the entry unit 28 in the PC 4 (YES in Step #51), the control unit 36 stores (registers) the entered data such as registration information in the external memory section 35 (Step #52). Subsequently, the control unit 36 of the PC 4 transmits the unique information of the PC 4 and those of the cameras 2 administered by the newly installed data storing server 3 (cameras 2 in the group as data supplying ends to the data storing server 3) to the data storing server 3 (Step #53).

On the other hand, if the data storing server 3 receives the unique information of the PC 4 and those of the cameras 2 (YES in Step S61), the data storing server 3 stores these pieces of unique information in the storage 23 (Step #62) and transmits to the PC 4 a setting completion notifying data to the effect that the cameras 2 and the PC 4 are respectively set as data supplying ends to this data storing server 3 and data receiving end from this data storing server 3 (Step #63).

If the PC 4 receives the setting completion notifying data from the data storing server 3 (YES in Step #54), the control unit 36 ends the processing after displaying a message to the effect that the setting of the newly installed data storing server 3 as a communication partner (data supplying end) of this PC 4 was completed on the display unit 27 (Step #55).

As described above, the PC 4 receives the image data from the cameras 2 and the image photographed in the past from the data storing servers 3. Thus, the state of the object can be visually confirmed substantially in real time by watching the images of the object supplied from the camera 2 and the past state of the object can be visually confirmed by watching the images of the object supplied from the data storing server 3.

In this embodiment, a plurality of data storing servers 3 are installed on the communication network 6, a plurality of cameras 2 connected with the communication network 6 are divided into a plurality of groups, these groups being related to the respective data storing servers 3 in correspondence, and the respective data storing servers 3 import data including images from the cameras 2 belonging to the corresponding groups and supply them to the PC 4. Thus, in the case of additionally installing the additional server function, it is not necessary to stop the operation of the image data delivery system as before, thereby avoiding a situation where the user cannot receive the image data delivery service.

Since each data storing server 3 is constructed to handle the data from some of a plurality of cameras 2 connected with the communication network 6, the performance thereof can be improved only to a necessary extent corresponding to the number of the cameras supplying the data to the data storing server 3 and the number of the PCs 4 receiving the data supply from the data storing server 3, and each data storing server 3 can have a relatively small size. Therefore, the installation place of the data storing server 3 is not limited.

Further, since the sounds are outputted and the occurrences of events are notified in synchronism with the display of the images, the states of the objects being photographed by the cameras 2 and the states of their surrounding environments can be supplied in more detail to the user, thereby improving the service of the image data delivery system.

Furthermore, the pause button 63, the first and second forward button 64, 65, the first and second rewind buttons 66, 67, the first, second and third mode changeover buttons 68, 69, 94 are displayed on the playback view display screen 58, and the stop button 88, the pause button 89, the first and second rewind buttons 90, 91 are displayed on the single liveview display screen 57. Thus, it is possible to quickly display a desired image, to observe an image obtained at a desired timing, or to perform another operation by interrupting the display of the image. Therefore, image browsing operability is increased to improve the service of the image data delivery system.

Further, if a detection signal presenting an occurrence of an event is outputted from the human presence sensor 15 or the sound pressure sensor 16, an event data is generated and transmitted to the data storing server 3 and the PC 4 together with an image, and the PC 4 displays the event data together with the image on the display unit 27 upon receiving the event data. Thus, the user can comprehend an occurrence of a situation where a person intruded into a specified area or the sound pressure exceeded a predetermined threshold value in a specified area. This can also improve the service of the image data delivery system.

Furthermore, since the search screen 76 is displayed to search the images using the event data as the search key out of the image data stored in the data storing server 3 and the images corresponding to the event data entered on the search screen 76 are displayed, the user can more easily search a desired image, thereby further improving the service of the image data delivery system.

Further, the links are provided in the display area for the event-related data displayed in the event data display area 42 on the multiple liveview display screen 45, and images photographed at and after a timing going back from an occurred timing of the event data by a specified period are obtained from the data storing server 3 and displayed by performing a specified operation to the display area of the event data. Thus, the user can quickly browse the desired images photographed in the past, and can securely visually confirm the image when the event occurred by seeing the images at and after the timing going back from the occurred timing of the event by the specified period. Therefore, the service of the image data delivery system can be even more improved.

The names of the groups and the names of the cameras 2 in the respective groups are displayed in tree view in the administration information display area 41, and the images displayed in the image display area 40 are switched over to those supplied from the camera 2 belonging to the operated group through a specified operation to the display area of the group name. Thus, the images in a desired image pickup area can be quickly displayed on the PC 4, whereby a further improvement in the service of the image data delivery system can be accomplished.

In addition to or in place of the foregoing embodiment, the modifications may be made.

The technical application of the present invention is not limited to the aforementioned PC 4 as an apparatus for receiving the supply of image data from the cameras 2 and the data storing servers 3, and the present invention is also applicable to an electronic apparatus having a display unit and a mobile communication apparatus such as a mobile information terminal (PDA: personal digital assistant) or a mobile computer.

The number of cameras per group in the case of grouping a plurality of cameras 2 can be suitably set according to the performance of the data storing servers 3.

As described above, an image data delivery system comprises at least one group including an image pickup apparatus for picking up a light image of an object to generate image data and a server for importing image data from the image pickup apparatus via a communication network and storing the imported image data; and an image displaying apparatus for importing image data from the image pickup apparatus or the server via the communication network and displaying an image of the imported image data. The image displaying apparatus has a first display mode for displaying an image upon receiving image data from the image pickup apparatus and a second display mode for displaying an image upon receiving image data from the server.

Further, there are provided a plurality of groups, each group including an image pickup apparatus for picking up a light image of an object to generate image data and a server for importing image data from the image pickup apparatus via a communication network and storing the imported image data.

With this construction, the server receives and stores image data from the image pickup apparatus belonging to the corresponding group. The image displaying apparatus displays images received from the image pickup apparatus in the first display mode while receiving and displaying the server-stored images from the server.

Thus, by means of the image displaying apparatus, the images being obtained by the image pickup apparatus can be visually confirmed in real time in the first display mode and the images obtained by the image pickup apparatuses in the past can be visually confirmed in the second display mode.

The plurality of image pickup apparatuses are divided into the plurality of groups, and the servers are related to the groups in correspondence and receive and store image data from the image pickup apparatuses belonging to the corresponding groups. Thus, it is not necessary to stop the operation of the system as before in the case of improving a server function (improving a delivery performance including a storage capacity). Therefore, a situation where users cannot receive an image delivery service can be avoided.

Further, since each server is constructed to handle the image data from some of a plurality of image pickup apparatuses connected with the communication network, the performance can be improved only to a necessary extent corresponding to loads (the number of the image pickup apparatuses supplying image data and the number of the image displaying apparatuses receiving image data). Each server can have a relatively small size. Therefore, a degree of freedom in selecting the installation places of the servers can be extended.

Also, the image displaying apparatus may be preferably provided with a display controller for causing an entry display image which allows the user to input an instruction to change an image whose data is stored in the server and which is or was picked up before or after an image being currently displayed on a display screen, and an instruction to temporarily stop display of an image of image data supplied from the server on the display screen, an input device for operating the entry display image, and a request information generator in response to a specified entry to the entry display image by means of the input device for generating first request information for requesting to the server to supply image data of an image picked up before or after an image currently displayed on the display screen is or was picked up, or second request information for requesting to the server to temporarily stop an image supply. The server supplies image data corresponding to the first request information to the image displaying apparatus upon receiving the first request information from the request information generator while temporarily stopping the image supply to the image displaying apparatus upon receiving the second request information from the request information generator.

With this construction, the image supplied from the server can be changed to the one picked up before or after the image being currently displayed on the display screen is or was picked up or the image display on the display screen can be temporarily stopped.

Thus, it is possible to quickly display or observe an image picked up at a desired timing or perform another operation by interrupting the image display. As a result, the service of the image data delivery system can be improved.

Further, it may be preferable that each image pickup apparatus includes a sound input device for inputting sounds, and transmits a data of sounds inputted by the sound input device and a synchronization signal of the sound data and image data to the server or the image displaying apparatus together with the image data; each server stores the sound data received from the image pickup apparatus while relating the sound data to the image data; and the image displaying apparatus includes a sound output device for outputting sound data received from the image pickup apparatus as sounds, and displays an image of image data received from the image pickup apparatus in synchronism with the output of sounds by the sound output device based on a sound data received from the image pickup apparatus in the first display mode while displaying an image being received from the server in synchronism with the output of sounds by the sound output device based on a sound data related to the image being received from the server in the second display mode.

With this construction, the image received from the image pickup apparatus can be displayed in synchronism with the output of sounds by the sound output device based on the sound data received from the image pickup apparatus in the first display mode, whereas the image being received from the server can be displayed in synchronism with the output of sounds by the sound output device based on the sound data related to the image being received from the server in the second display mode.

Since the sounds generated while the image was picked up can be outputted, the service of the image data delivery system can be improved as compared to image data delivery systems supplying only image data.

Preferably, the group may be further provided with an event data generator for generating event data concerning an occurrence of an event. In this case, the image displaying apparatus displays the event data together with the image upon receiving the event data.

It may be preferable that the server receives event data together with image data, and stores the event data in relation with the image data, the image displaying apparatus displays a search screen which allows search of a specified one from the stored image data by using event data as a search key, and requests the server to transmit image data related to the event data, and displays an image of the image data transmitted from the server.

Moreover, it may be preferable that the server receives event data together with image data, and stores the event data in relation with the image data, and the image displaying apparatus includes an input device for operating a display area of the event data to request the server to transmit image data related to the event data, and displays an image of the image data transmitted from the server.

Preferably, the transmitted image data may be data of images obtained at and after a point of time going back a specified time from the occurred timing of the event.

It may be preferable that each group and the image pickup apparatus belonging to the group are respectively given identifying information for identifying them, and the image displaying apparatus displays identifying information to allow the user to select a desired image based on the identifying information, and request the server to transmit data of the selected image.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image data delivery system, comprising:
at least one group including:
an image pickup apparatus for picking up a light image of an object to generate image data; and
a server for importing image data from the image pickup apparatus via a communication network and storing the imported image data; and
an image displaying apparatus for importing image data from the image pickup apparatus or the server via the communication network and displaying an image of the imported image data, the image displaying apparatus having a first display mode for displaying an image upon receiving image data from the image pickup apparatus and a second display mode for displaying an image upon receiving image data from the server.

2. An image data delivery system according to claim 1, wherein a plurality of groups are provided, each group including:
an image pickup apparatus for picking up a light image of an object to generate image data; and
a server for importing image data from the image pickup apparatus via a communication network and storing the imported image data.

3. An image data delivery system according to claim 2, wherein each group includes a plurality of image pickup apparatuses.

4. An image data delivery system according to claim 1, wherein the image displaying apparatus includes:
a display controller for causing an entry display image which allows the user to input an instruction to change an image whose data is stored in the server and which is or was picked up before or after an image being currently displayed on a display screen, and an instruction to temporarily stop display of an image of image data supplied from the server on the display screen;
an input device for operating the entry display image; and
a request information generator in response to a specified entry to the entry display image by means of the input device for generating first request information for requesting to the server to supply image data of an image picked up before or after an image currently displayed on the display screen is or was picked up, or second request information for requesting to the server to temporarily stop an image supply; and
the server supplies image data corresponding to the first request information to the image displaying apparatus upon receiving the first request information from the request information generator while temporarily stopping the image supply to the image displaying apparatus upon receiving the second request information from the request information generator.

5. An image data delivery system according to claim 4, wherein:
the image pickup apparatus includes a sound input device for inputting sounds, and transmits data of sounds inputted by the sound input device and a synchronization signal of the sound data and image data to the server or the image displaying apparatus together with the image data;
the server stores the sound data received from the image pickup apparatus while relating the sound data to the image data; and
the image displaying apparatus includes a sound output device for outputting sound data received from the image pickup apparatus as sounds, and displays an image of image data received from the image pickup apparatus in synchronism with the output of sounds by the sound output device based on sound data received from the image pickup apparatus in the first display mode while displaying an image being received from the server in synchronism with the output of sounds by the sound output device based on sound data related to the image being received from the server in the second display mode.

6. An image data delivery system according to claim 1, wherein:
the image pickup apparatus includes a sound input device for inputting sounds, and transmits data of sounds inputted by the sound input device and a synchronization signal of the sound data and image data to the server or the image displaying apparatus together with the image data;
the server stores the sound data received from the image pickup apparatus while relating the sound data to the image data; and
the image displaying apparatus includes a sound output device for outputting sound data received from the image pickup apparatus as sounds, and displays an image of image data received from the image pickup apparatus in synchronism with the output of sounds by the sound output device based on sound data received from the image pickup apparatus in the first display mode while displaying an image being received from the server in synchronism with the output of sounds by the sound output device based on sound data related to the image being received from the server in the second display mode.

7. An image data delivery system according to claim 1, wherein the group further includes an event data generator for generating event data concerning an occurrence of an event, and the image displaying apparatus displays the event data together with the image upon receiving the event data.

8. An image data delivery system according to claim 7, wherein the server receives event data together with image data, and stores the event data in relation with the image data, the image displaying apparatus displays a search screen which allows search of a specified one from the stored image data by using event data as a search key, and requests the server to transmit image data related to the event data, and displays an image of the image data transmitted from the server.

9. An image data delivery system according to claim 8, wherein the transmitted image data is data of images obtained at and after a point of time going back a specified time from the occurred timing of the event.

10. An image data delivery system according to claim 7, wherein the server receives event data together with image data, and stores the event data in relation with the image data, and the image displaying apparatus includes an input device for operating a display area of the event data to request the server to transmit image data related to the event data, and displays an image of the image data transmitted from the server.

11. An image data delivery system according to claim 10, wherein the transmitted image data is data of images obtained at and after a point of time going back a specified time from the occurred timing of the event.

12. An image data delivery system according to claim 2, wherein each group and the image pickup apparatus belonging to the group are respectively given identifying information for identifying them, and the image displaying apparatus displays identifying information to allow the user to select a desired image based on the identifying information, and request the server to transmit data of the selected image.
